(19) United States
(12) Patent Application Publication
(10) Pub. No.: US 2024/0097492 A1
(43) Pub. Date: Mar. 21, 2024

(54) CHARGING APPARATUS THAT EXECUTES WIRELESS CHARGING

(71) Applicant: Panasonic Intellectual Property Management Co., Ltd., Osaka (JP)

(72) Inventors: Dai KIMURA, Kanagawa (JP); Takahiro SUZUKI, Kanagawa (JP); Atsutoshi NARAKI, Kanagawa (JP)

(73) Assignee: Panasonic Intellectual Property Management Co., Ltd., Osaka (JP)

(21) Appl. No.: 18/526,425

(22) Filed: Dec. 1, 2023

Related U.S. Application Data
(63) Continuation of application No. PCT/JP2022/002629, filed on Jan. 25, 2022.

(30) Foreign Application Priority Data
Jun. 2, 2021 (JP) 2021-092968

(51) Int. Cl. H02J 50/10; H02J 50/80; H02J 50/90

(52) U.S. Cl. CPC H02J 50/10; H02J 50/80; H02J 50/90; B60R 16/03

(57) ABSTRACT

A deriver derives a difference defined as a distance between a position of a charging coil and a position of an electronic appliance. An extractor extracts a detection tolerance from a table stored in a table storage, based on information related to a model of the electronic appliance. A transmitter transmits the difference and the detection tolerance to the electronic appliance. The electronic appliance determines a first power when a magnitude of a combination of the difference and the detection tolerance is equal to or smaller than a threshold value and determines a second power when the magnitude of the combination of the difference and the detection tolerance is larger than the threshold value. The first power is larger than the second power. A power controller adjusts a magnitude of power to be transported from the charging coil according to an instruction from the electronic appliance.

### BACKGROUND

### 1. Field

The present disclosure relates to charging technology and, in particular, to charging apparatuses that execute wireless charging.

### 2. Description of the Related Art

A charging apparatus that charges a built-in battery by transporting power from a charging coil to an induction coil by the action of electromagnetic induction has been developed. The charging apparatus has a built-in charging coil that is excited by an AC power source, and an electronic appliance has a built-in induction coil that is electromagnetically coupled to the charging coil. Further, the electronic appliance rectifies the AC current induced in the induction coil and supplies the current to the built-in battery to charge the battery. Further, in order to improve the charging efficiency, the charging apparatus identifies the position of the induction coil in the electronic appliance and moves the dielectric coil near the identified position (see, for example, patent literature 1).
[Patent Literature 1] JP 2009-247194

The closer the charging coil is to a position where the charging coil and the dielectric coil face each other, the better the charging efficiency. Since the charging apparatus cannot notify the electronic appliance of the positional relationship between the charging coil and the dielectric coil, however, added value such as high power charging is not efficiently provided.

### SUMMARY

The present disclosure addresses the issue described above, and a purpose thereof is to provide a technology for efficiently executing added value such as high-power charging in wireless charging.

A charging apparatus according to an embodiment of the present disclosure is a charging apparatus for an electronic appliance that includes a built-in induction coil that is electromagnetically coupled and a built-in battery that is charged with power induced in the induction coil, the charging apparatus comprising: a support plate on which the electronic appliance is placeable; a detector that detects a position of the electronic appliance placed on the support plate; a deriver that derives a difference defined as a distance between a position of a charging coil for transporting power to the electronic appliance for which the position is detected by the detector and a position of the electronic appliance detected by the detector; a table storage that stores a table showing correspondence between a model of the electronic appliance placeable on the support plate and a detection tolerance occurring when the position of the electronic appliance is detected; an acquirer that acquires information related to the model of the electronic appliance by executing communication with the electronic appliance placed on the support plate; an extractor that extracts the detection tolerance from the table stored in the table storage, based on the information acquired by the acquirer; a transmitter that transmits the difference derived by the deriver and the detection tolerance detected by the detector to the electronic appliance; and a power controller that adjusts a magnitude of power to be transported from the charging coil according to an instruction from the electronic appliance to which the transmitter transmits the difference and the detection tolerance. The electronic appliance determines a first power when a magnitude of a combination of the difference and the detection tolerance is equal to or smaller than a threshold value and determines a second power when the magnitude of the combination of the difference and the detection tolerance is larger than the threshold value, and the first power is larger than the second power.

Optional combinations of the aforementioned constituting elements, and implementations of the present disclosure in the form of methods, apparatuses, systems, recording mediums, and computer programs may also be practiced as additional embodiments of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1 is a perspective view showing the interior of a vehicle according to the embodiment;

FIG. 2 is a perspective view showing the structure of the charging apparatus of FIG. 1;

FIG. 3 is a perspective view showing a state in which an electronic appliance is placed on the charging apparatus of FIG. 2;

FIG. 4 is a perspective view showing a state in which a part of the charging apparatus of FIG. 2 is removed;

FIG. 5 is a top view showing the structure of the charging apparatus of FIG. 4;

FIG. 6 is a cross-sectional view showing the structure of the charging apparatus of FIG. 2;

FIG. 7 is a cross-sectional view showing the structure of the support plate of the charging apparatus of FIG. 2;

FIG. 8 is a plan view showing the structure of the support plate of the charging apparatus of FIG. 2;

FIG. 9 shows the configuration of the charging apparatus of FIG. 2;

FIG. 10 shows an overview of the operation of the charging apparatus of FIG. 9;

FIG. 11 shows a data structure of the table stored in the table storage of FIG. 9;

FIG. 12 shows an overview of the charging process in the charging apparatus of FIG. 9;

FIG. 13 is a flowchart showing a charging procedure executed by the charging apparatus of FIG. 9;

FIG. 14 is a flowchart illustrating another charging procedure executed by the charging apparatus of FIG. 9;

FIG. 15 is a flowchart showing a charging procedure executed by the electronic appliance of FIG. 3; and

FIG. 16 is a flowchart showing a detection tolerance calculation procedure executed by the charging apparatus of FIG. 9.

### DETAILED DESCRIPTION

The invention will now be described by reference to the preferred embodiments. This does not intend to limit the scope of the present invention, but to exemplify the invention.

A brief summary will be given before describing the present disclosure in specific details. An embodiment of the present disclosure relates to a charging apparatus capable of non-contact charging, i.e., wireless charging. The charging apparatus performs wireless charging for an electronic appliance placed on the upper surface of the charging apparatus. An example of an electronic appliance is a portable terminal apparatus such as a smartphone. As an international standard for wireless charging, Qi was formulated in WPC (Wireless Power Consortium). The Qi standard defines charging by low-power transportation (hereinafter referred to as “low-power charging”) and charging by high-power transportation (hereinafter referred to as “high-power charging”). For example, low-power charging charges a target with a maximum power of 5 W, and high-power charging charges a target with 15 W or more. In such wireless charging, the closer the charging coil of the charging apparatus and the dielectric coil of the electronic appliance to the relative positions where they face each other, the better the charging efficiency. In the charging apparatus according to the embodiment, therefore, the charging coil is moved to approach the dielectric coil of the electronic appliance.

When the charging apparatus receives an instruction (hereinafter referred to as “power instruction”) from the electronic appliance regarding the amount of power to be transported, that is, high power or low power, the charging apparatus adjusts the power magnitude according to the power instruction before transporting the power to the electronic appliance. As described above, the closer the charging coil is to the position where the charging coil and the dielectric coil face each other, the better the charging efficiency. Therefore, it is desirable that the magnitude of the power indicated in the power instruction is determined according to the positional relationship between the charging coil and the dielectric coil. Until now, however, the positional relationship between the charging coil and the dielectric coil has not been communicated from the charging apparatus to the electronic appliance. Therefore, the magnitude of the power indicated in the power instruction is not determined according to the positional relationship between the charging coil and the dielectric coil. In such a situation, it is required to efficiently provide added value such as high-power charging.

The charging apparatus according to this embodiment detects a difference between the position of the charging coil and the position of the dielectric coil. The detection tolerance of this difference generally varies depending on the model of the electronic appliance. Therefore, the charging apparatus stores a table in advance in which the correspondence between the model of the electronic appliance and the detection tolerance is shown. The charging apparatus alternatively stores the detection tolerance determined by calculation or the like in the form of a table. When information (hereinafter, “model notification”) related to the model of the electronic appliance is received from the electronic appliance, the charging apparatus refers to the table and extract the detection tolerance. The charging apparatus transmits information (hereinafter referred to as “placement report”) including the difference and the detection tolerance to the electronic appliance. The electronic appliance determines the magnitude of the power to be transported, based on the difference and the detection tolerance included in the received placement report. The electronic appliance transmits a power indication including the determined magnitude of power to the charging apparatus. As a result, the charging apparatus transports power having a magnitude corresponding to the positional relationship between the charging coil and the dielectric coil. This corresponds to high power charging or low power charging being determined according to the positional relationship between the charging coil and the dielectric coil.

In this process, the electronic appliance is required to have the capability to determine the magnitude of power based on the difference and the detection tolerance accurately. However, it is possible that the electronic appliance is an inferior product that does not have such capability. In consideration of safety, it should be avoided to provide added value such as high-power charging for an inferior product, and the charging apparatus is required to determine whether the electronic appliance is highly reliable.

In this embodiment, a common key is stored in each of the charging apparatus and a highly reliable electronic appliance, and the electronic appliance and the charging apparatus execute an encrypted pre-mutual authentication process. When the pre-mutual authentication process is successful, the charging apparatus determines that the reliability of the electronic appliance is high, transmitting the above-described placement report and receiving the power instruction as described above. Therefore, added value such as high power charging can be executed. When the pre-mutual authentication process fails, on the other hand, the charging apparatus determines that the reliability of the electronic appliance is low. The charging apparatus does not transmit the above-described placement report or receive a power instruction and executes low power charging. The terms “parallel” and “orthogonal” in the following description not only encompass completely parallel or orthogonal but also encompass slightly off-parallel and off-orthogonal within the margin of error. The term “substantially” means identical within certain limits.

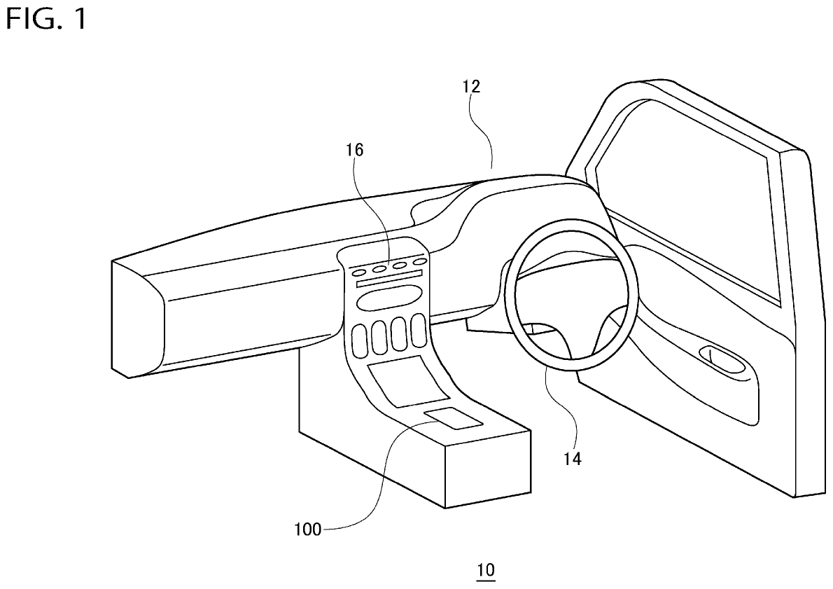

FIG. 1 is a perspective view showing the interior of a vehicle 10 according to the embodiment. A steering wheel 14 is provided on the front right side in a vehicle cabin 12 of the vehicle 10. The steering wheel 14 may be provided on the left side. Further, a center console 16 is disposed to the side of the steering wheel 14, i.e., in the front center of the vehicle cabin 12 of the vehicle 10. Further, a charging apparatus 100 is provided behind the center console 16 in the vehicle cabin 12.

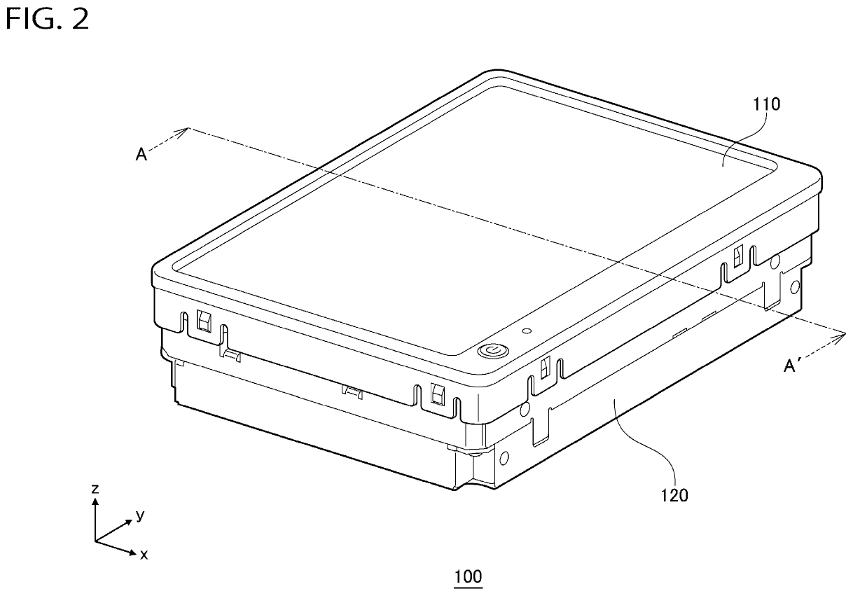

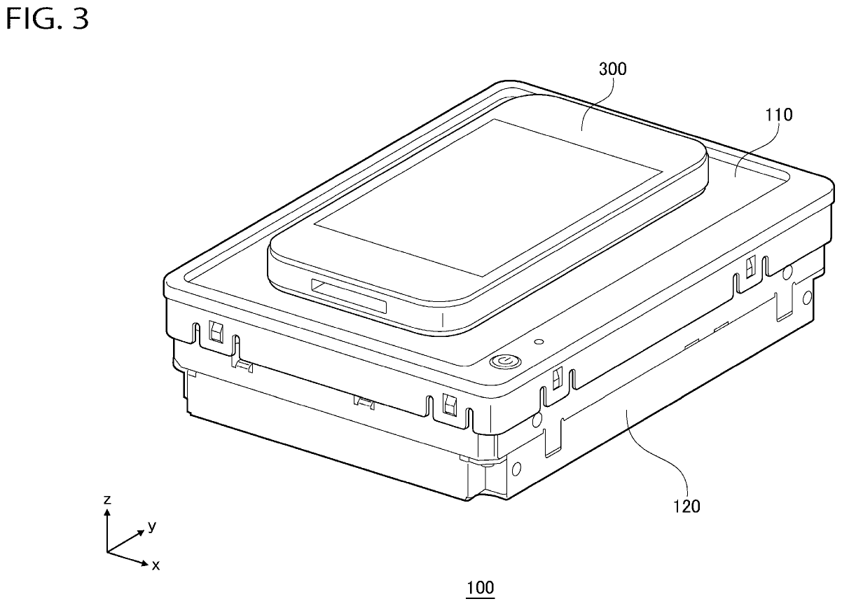

FIG. 2 is a perspective view showing the structure of the charging apparatus 100. FIG. 3 is a perspective view showing a state in which an electronic appliance 300 is placed on the charging apparatus 100. As shown in FIGS. 2 and 3, an orthogonal coordinate system including an x axis, y axis, and z axis is defined. The x axis and y axis are orthogonal to each other. The z axis is perpendicular to the x axis and the y axis and extends in the direction of thickness of the charging apparatus 100. The positive directions of the x axis, y axis, and z axis are defined in the directions of arrows in FIGS. 2 and 3, and the negative directions are defined in the directions opposite to those of the arrows. The positive direction of the z axis may be referred to as “above”, “upper side”, “upper surface side”, and the negative direction of the z axis may be referred to as “below”, “lower side”, “lower surface side”.

The charging apparatus 100 includes a support plate 110 and a main body case 120. The combination of the support plate 110 and the main body case 120 has a box shape. The support plate 110 is disposed on the upper side of the main body case 120. The electronic appliance 300 is an apparatus subject to charging by the charging apparatus 100, and as described above, is a portable terminal apparatus such as a smartphone. The electronic appliance 300 includes a built-in induction coil that is electromagnetically coupled and a built-in battery that is charged with power induced in the induction coil. When the electronic appliance 300 is placed on the support plate 110, the charging apparatus 100 charges the electronic appliance 300.

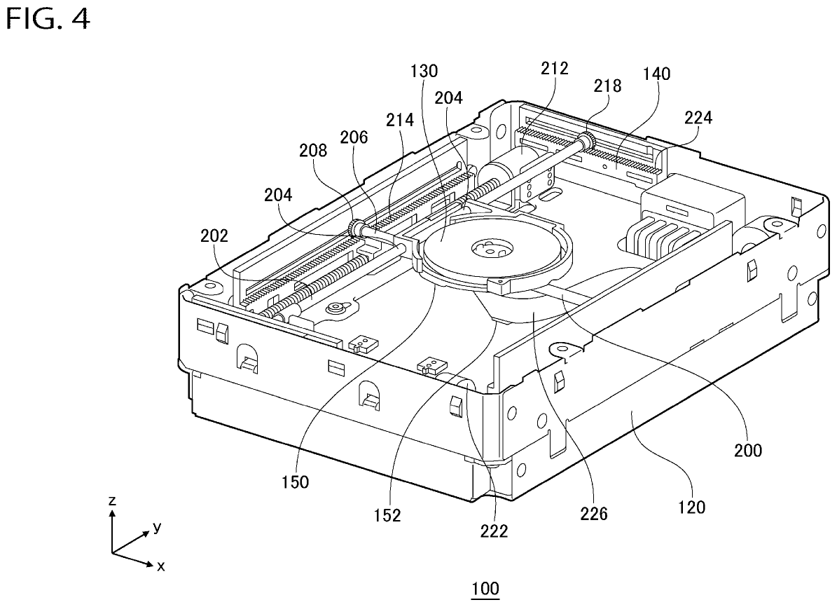

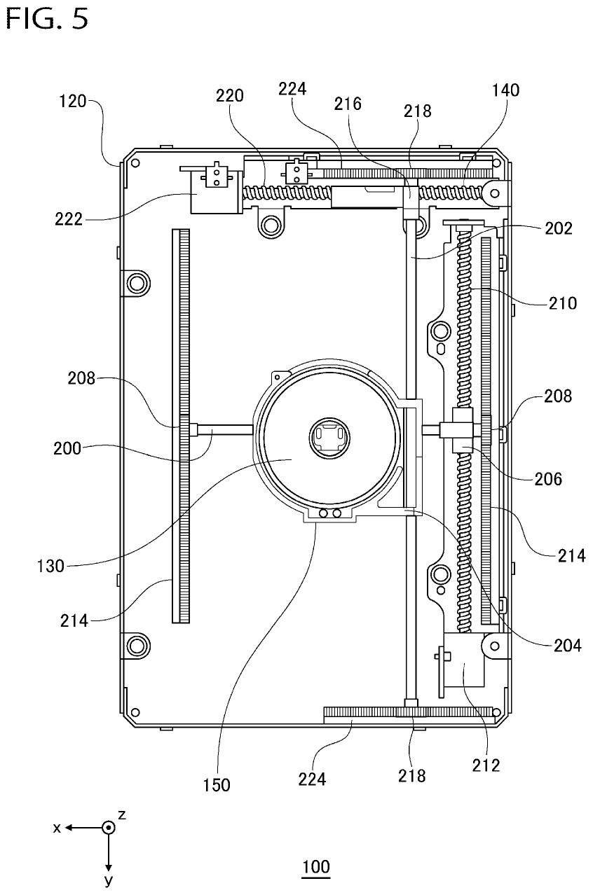

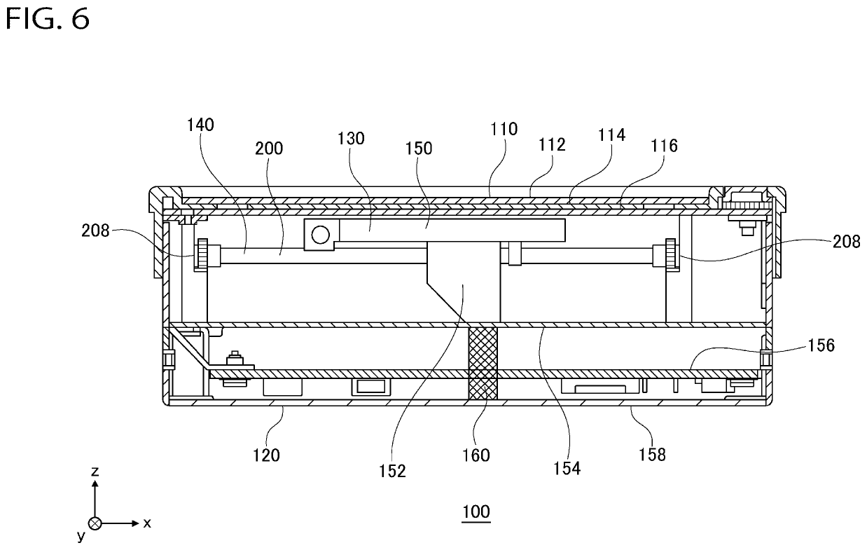

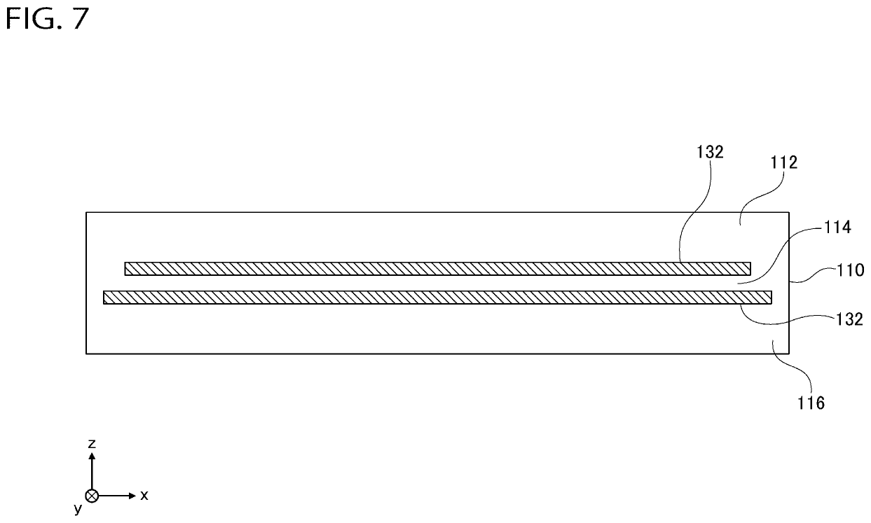

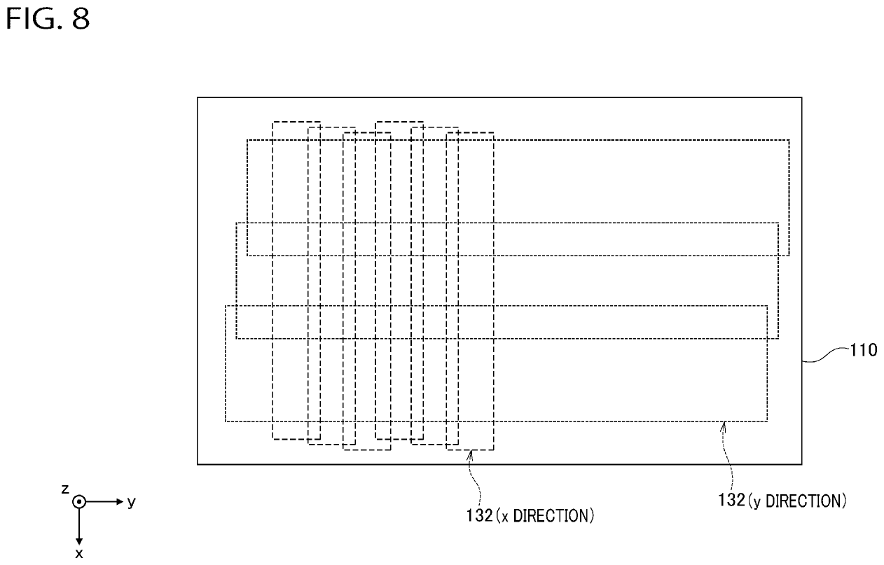

FIG. 4 is a perspective view showing a state in which a part of the charging apparatus 100 is removed. This corresponds to a state in which the support plate 110 is removed from the charging apparatus 100 of FIG. 2. FIG. 5 is a top view showing the structure of the charging apparatus 100 of FIG. 4. FIG. 6 is a cross-sectional view showing the structure of the charging apparatus 100 and is a cross-sectional view along the A-A′ line of FIG. 2. FIG. 7 is a cross-sectional view showing the structure of the support plate 110 of the charging apparatus 100. FIG. 8 is a plan view showing the structure of the support plate 110 of the charging apparatus 100. In the main body case 120, the charging coil 130 is provided to be movable in the horizontal direction in a state in which the charging coil 130 faces the lower surface side of the support plate 110 of FIG. 2. In the main body case 120 are also provided a driver 140 for causing the charging coil 130 to move horizontally in such a manner that the charging coil 130 faces the lower surface side of the support plate 110, and a control apparatus (not shown) connected to the driver 140 and the charging coil 130.

As shown in FIG. 6, a surface plate 112, a middle plate 114, and a back plate 116 are stacked in the support plate 110 in the vertical direction. The surface plate 112 and the back plate 116 are made of a synthetic resin, and the middle plate 114 is made of a glass-filled epoxy electronic substrate. Thereby, the magnetic flux from the charging coil 130 described later can pass through the support plate 110 in the direction of the electronic appliance 300. Further, as shown in FIGS. 7 and 8, a plurality of detection coils 132 are provided on the front and back surfaces of the middle plate 114 so as to be distributed within the x-y plane of the middle plate 114. For example, a plurality of detection coils 132 extending in the x axis direction and a plurality of detection coils 132 extending in the y axis direction are arranged in a matrix so as to overlap each other. Such an arrangement of the plurality of detection coils 132 is by way of one example, and the plurality of detection coils 132 may be arranged in a matrix shape so as not to overlap. By using the plurality of detection coils 132, it is possible to detect whether the electronic appliance 300 is placed on the support plate 110 and at which position in the support plate 110 the electronic appliance 300 is placed. Based on the detection result, the driver 140 moves the charging coil 130 until it approaches a position facing the coil of the electronic appliance 300.

As shown in FIGS. 4 and 5, the charging coil 130 has an annular shape in which a wire rod is wound in a spiral shape. The outer peripheral side and the lower surface side of the charging coil 130 are held by a holding body 150 made of a synthetic resin. On the lower surface of the holding body 150 is formed, as shown in FIG. 6, a support leg 152 made of a synthetic resin so as to extend downward of the charging coil 130 and to be integrated with the holding body 150. A gap of 0.3 mm is provided between the lower surface of the support leg 152 and the upper surface of a metal support plate 154 disposed below the support leg 152. Due to this gap, the lower surface of the support leg 152 does not contact the upper surface of the support plate 154 when the charging coil 130 is moved. A control board 156 and a lower surface plate 158 of the main body case 120 are disposed below the support plate 154. For example, the above-described control apparatus is provided on the control board 156. A support 160 penetrating the control board 156 is provided between the lower surface of the support plate 154 and the upper surface of the lower surface plate 158. That is, the lower surface side of the support plate 154 is supported by the lower surface plate 158 of the main body case 120 via the support 160 in order to increase the strength against overload.

As shown in FIGS. 4 and 5, the driver 140 has a Y axis direction drive shaft 200 and an X axis direction drive shaft 202. The intermediate portions of the Y axis direction drive shaft 200 and the X axis direction drive shaft 202 contact portions of the holding body 150 other than the portion where the charging coil 130 is held. In the holding body 150, therefore, a through hole (not shown) through which the Y axis direction drive shaft 200 penetrates and a through hole 204 through which the X axis direction drive shaft 202 penetrates are provided to intersect, maintaining a predetermined vertical interval. The Y axis direction drive shaft 200 and the X axis direction drive shaft 202 contact the through hole 204.

A worm wheel 206 is provided on one end of the Y axis direction drive shaft 200, and a gear 208 is provided in the worm wheel 206. Further, a gear 208 is also provided on the other end of the Y axis direction drive shaft 200 where the worm wheel 206 is not provided. The worm wheel 206 engages with a worm 210, and the worm 210 is connected to a Y axis motor 212. The gears 208 on both sides engage with a gear plate 214, respectively. With this structure, when the Y axis motor 212 is driven, the worm 210 rotates, which moves the worm wheel 206 in the y axis direction along with the Y axis direction drive shaft 200. Further, the charging coil 130 integrated with the Y axis direction drive shaft 200 also moves in the Y axis direction. The mechanical unit moved by the motor will be referred to as a drive load hereinafter.

A worm wheel 216 is provided on one end of the X axis direction drive shaft 202, and a gear 218 is provided in the worm wheel 216. Further, a gear 218 is also provided on the other end of the X axis direction drive shaft 202 where the worm wheel 216 is not provided. The worm wheel 216 engages with a worm 220, and the worm 220 is connected to a X axis motor 222. The gears 218 on both sides engage with the gear plate 224, respectively. With this structure, when the X axis motor 222 is driven, the worm 220 rotates, which moves the worm wheel 216 in the x axis direction along with the X axis direction drive shaft 202. Further, the charging coil 130 integrated with the X axis direction drive shaft 202 moves in the x axis direction. A flexible wiring 226 shown in FIG. 4 energizes the charging coil 130. The end of the flexible wiring 226 is fixed to the side of the support leg 152.

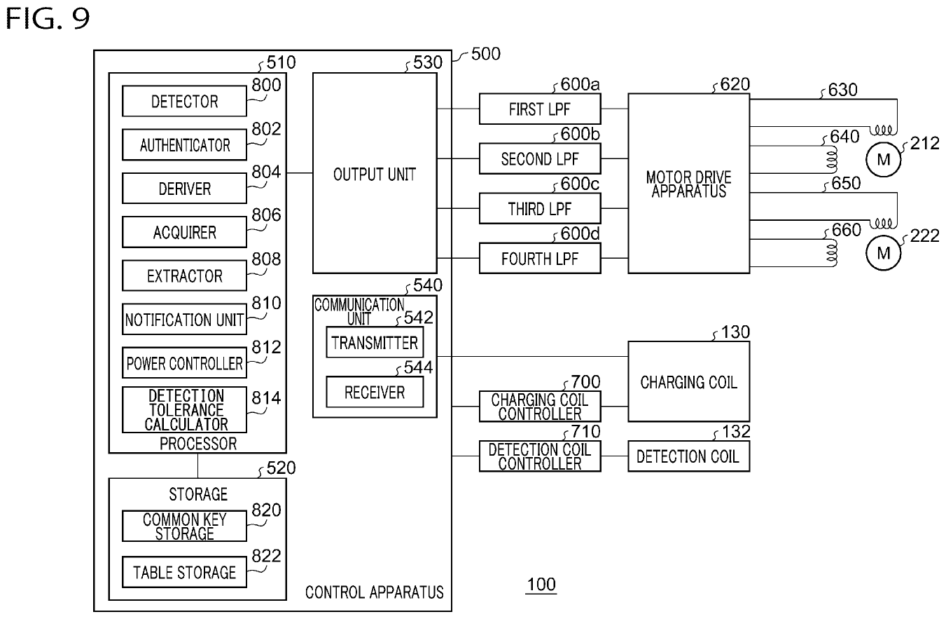

FIG. 9 shows the configuration of the charging apparatus 100. The charging apparatus 100 includes a charging coil 130, a detection coil 132, a Y axis motor 212, an X axis motor 222, a control apparatus 500, a first LPF 600a, a second LPF 600b, a third LPF 600c, a fourth LPF 600d, which are generically referred to as LPF (Low-Pass Filters) 600, a motor drive apparatus 620, a YA phase coil 630, a YB phase coil 640, an XA phase coil 650, an XB phase coil 660, a charging coil controller 700, and a detection coil controller 710. The control apparatus 500 includes a processor 510, a storage 520, an output unit 530, and a communication unit 540.

The processor 510 includes a detector 800, an authenticator 802, a deriver 804, an acquirer 806, an extractor 808, a notification unit 810, a power controller 812, and a detection tolerance calculator 814. The storage 520 includes a common key storage 820, a table storage 822. The communication unit 540 includes a transmitter 542 and a receiver 544. Hereinafter, (1) the charging function in the charging apparatus 100, (2) the communication function in the charging apparatus 100, and (3) the charging process by the charging apparatus 100 will be described in this order.

### (1) Charging Function in the Charging Apparatus 100

The plurality of detection coils 132 are provided as described above, but they are discussed generically here. The detection coil controller 710 is connected to the detection coil 132. The detection coil controller 710 acquires a detection result in each detection coil 132 by controlling the operation of the detection coil 132. The charging coil controller 700 outputs the detection result to the control apparatus 500.

The control apparatus 500 detects a position in which the induction coil of the electronic appliance 300 is disposed on the support plate 110, based on the detection result from the charging coil controller 700. The position that is detected (hereinafter referred to as the “detected position”) is indicated by an x axis coordinate and a y axis coordinate. The control apparatus 500 moves the charging coil 130 by rotating the Y axis motor 212 and the X axis motor 222 so that the charging coil 130 approaches the detected position. In particular, the control apparatus 500 moves the charging coil 130 in the x axis direction by rotating the X axis motor 222 and moves the charging coil 130 in the y axis direction by rotating the Y axis motor 212. That is, the Y axis motor 212 or the X axis motor 222 moves the position of the charging coil 130, and the control apparatus 500 controls how the Y axis motor 212 or the X axis motor 222 is driven. The X axis motor 222 and the Y axis motor 212 are generically referred to as “motor”.

In order to rotate the Y axis motor 212 and the X axis motor 222, the control apparatus 500 performs micro-step driving. In micro-step driving, the drive waveform in the XA phase coil 650 is indicated as the A phase, and the drive waveform in the XB phase coil 660 is indicated as the B phase. The drive waveform of the A phase and the drive waveform of the B phase are related such that they are 90-degree phase shifted. In micro-step driving, therefore, the X axis motor 222 is rotated by outputting 90-degree phase shifted drive waveforms to the XA phase coil 650 and the XB phase coil 660. The same applies to the YA phase coil 630, the YB phase coil 640, and the Y axis motor 212.

In order to realize this micro-step driving, a table resulting from dividing one pseudo-sinusoidal wave period into a plurality of (e.g., 64) values stored in the storage 520. The processor 510 reads the value in the table at time intervals corresponding to the drive frequency and generates a pseudo sinusoidal drive waveform. The drive waveform has, for example, a stepped waveform. The drive waveform generated by the processor 510, and, for example, the drive waveform of the A phase in the x-axis direction, is output from the output unit 530 to the third LPF 600c. The third LPF 600c makes the shape of the drive waveform approach a sinusoidal wave by smoothing the stepped drive waveform. The third LPF 600c outputs the drive waveform to the motor drive apparatus 620. The motor drive apparatus 620 generates a drive current based on the received drive waveform and causes the drive current to flow in the XA phase coil 650.

It is only necessary to shift the driver waveform by 90 degrees to derive the B phase in the x axis direction. The processor 510, the output unit 530, the fourth LPF 600d, the motor drive apparatus 620, and the XB phase coil 660 operate in the same manner as described so far. With regard to the y-axis direction, too, the processor 510, the output unit 530, the first LPF 600a, the second LPF 600b, the motor drive apparatus 620, the YA phase coil 630, and the YB phase coil 640 operate in the same manner as described so far.

After moving the charging coil 130, the control apparatus 500 instructs the charging coil controller 700 to start charging. The charging coil controller 700 charges the electronic appliance 300 by controlling the operation of the charging coil 130 in response to the instruction from the control apparatus 500.

### (2) Communication Function in the Charging Apparatus 100

In the charging apparatus 100, the communication unit 540 is connected to the charging coil 130, and, in the electronic appliance 300, a communication unit (not shown) (hereinafter referred to as “electronic appliance communication unit”) is connected to the dielectric coil. As described above, the charging coil 130 and the dielectric coil can be electromagnetically coupled, and the communication unit 540 and the electronic appliance communication unit execute communication by using the electromagnetic coupling. By adjusting the load of the charging coil 130 and the dielectric coil, for example, the communication unit 540 and the electronic appliance communication unit transmit data in the form of fluctuations in the coupled field.

The transmitter 542 of the communication unit 540 in this embodiment transmits data modulated by FSK (Frequency Shift Keying) to the electronic appliance communication unit. Further, when the receiver 544 of the communication unit 540 receives data modulated by load modulation in the electronic appliance communication unit, the receiver 544 demodulates the data. These processes enable the exchange of information between the charging apparatus 100 and the electronic appliance 300.

### (3) Charging Process by the Charging Apparatus 100

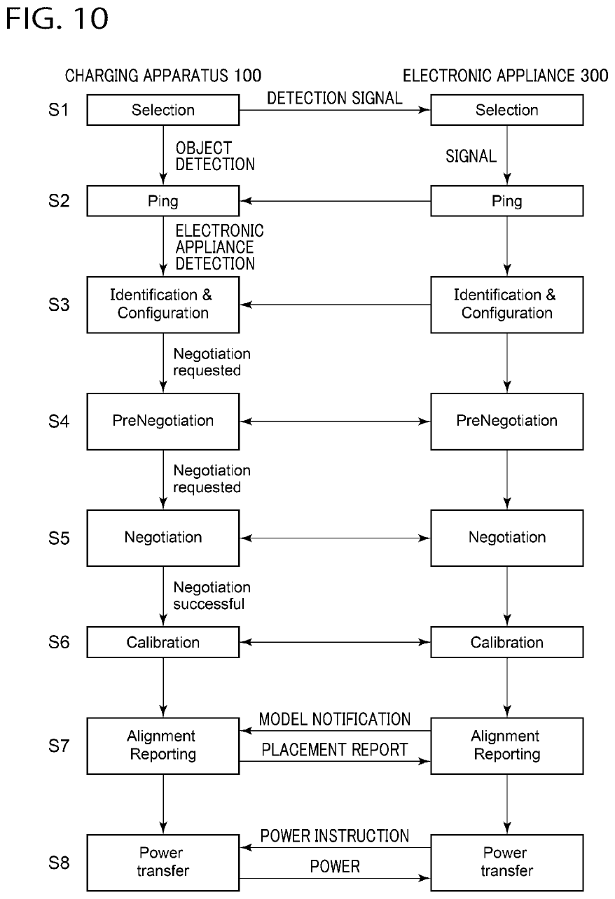

FIG. 10 shows an overview of the operation of the charging apparatus 100. High power charging or low power charging is executed by the charging apparatus 100 and the electronic appliance 300 performing a process comprising eight steps from S1 to S8. Of the eight steps, S1, S2, S3, S5, and S6 are the same steps as those of the Qi standard v1.3 of WPC, and S8 is a step derived from modifying a step in the Qi standard v1.3 in part. In this embodiment, S4 and S7 are added.

In the “Selection” of S1, when the electronic appliance 300 is placed on the surface plate 112, the charging coil controller 700 acquires the detection result of each detection coil 132 and outputs the detection result to the control apparatus 500. The detector 800 of the control apparatus 500 detects the position of the electronic appliance 300 placed on the surface plate 112 based on the detection result received from the detection coil 132. Since a known technique may be used to detect the position of the electronic appliance 300, a description thereof will be omitted here.

The processor 510 moves the charging coil 130 by rotating the Y axis motor 212 and the X axis motor 222 so that the charging coil 130 approaches the detected position derived in the detector 800. In this process, the processor 510 identifies the position of the charging coil 130, based on the rotational amount of the Y axis motor 212 and the X axis motor 222, and outputs the position of the charging coil 130 to the deriver 804. Further, the processor 510 also outputs the detected position derived by the detector 800 to the deriver 804. Subsequently, the processor 510 causes the charging coil 130 to transmit a detection signal for detection by the electronic appliance 300.

In “Ping” of S2, the electronic appliance communication unit of the electronic appliance 300 receiving the detection signal transmits Ping to the charging apparatus 100. The receiver 544 of the charging apparatus 100 receives Ping. By receiving Ping, the processor 510 recognizes the placement of the electronic appliance 300. In “Identification & Configuration” of S3, the electronic appliance communication unit of the electronic appliance 300 transmits identification information for identifying the electronic appliance 300 and configuration information indicating the configuration of the electronic appliance 300 to the charging apparatus 100. The receiver 544 of the charging apparatus 100 receives the identification information and the configuration information. The processor 510 receives the identification information and the configuration information.

In “PreNegotiation” of S4, an authentication process prior to Negotiation is executed between the charging apparatus 100 and the electronic appliance 300. The common key storage 820 of the storage 520 stores a common key to be used in the PreNegotiation. This common key is also stored in the highly reliable electronic appliance 300. The authenticator 802 executes a mutual authentication process encrypted by the common key stored in the common key storage 820, by executing communication with the electronic appliance 300 via the communication unit 540. For example, CMAC (Cipher-based MAC) or HMAC (Hash-based MAC) is used for the mutual authentication process. These are based on symmetric key cryptography such as AES (Advanced Encryption Standard) which requires less computation to generate/verify a MAC (Message Authentication Code) equivalent to signature and in which MAC can be truncated.

Since the common key is stored in the highly reliable electronic appliance 300, a successful mutual authentication process in the authenticator 802 corresponds to high reliability of the electronic appliance 300, and a process for determining high power charging or low power charging as in S7 and S8 described later is executed. When the mutual authentication process in the authenticator 802 fails, on the other hand, it corresponds to low reliability of the electronic appliance 300, and low power charging is executed. In that case, a process for determining high power charging or low power charging is not executed. Thereby, high power charging for an inferior electronic appliance 300 is avoided.

In “Negotiation” of S5, the authentication process according to the Qi standard is executed. That is, the authenticator 802 of the charging apparatus 100 executes the authentication process defined in the Qi standard power transportation procedure following the mutual authentication process in PreNegotiation. It should be noted here that the common key used in the mutual authentication process in PreNegotiation and the key used in the authentication process defined in the Qi standard power transportation procedure are different. In “Calibration” of S6, calibration is executed between the charging coil 130 of the charging apparatus 100 and the dielectric coil of the electronic appliance 300.

In “Alignment Reporting” of S7, the deriver 804 receives the position of the charging coil 130 and the detected position of the electronic appliance 300. The position of the charging coil 130 and the detected position of the electronic appliance 300 are both indicated by coordinates. The deriver 804 derives a difference between the position of the charging coil 130 and the detected position of the electronic appliance 300 by vector operation.

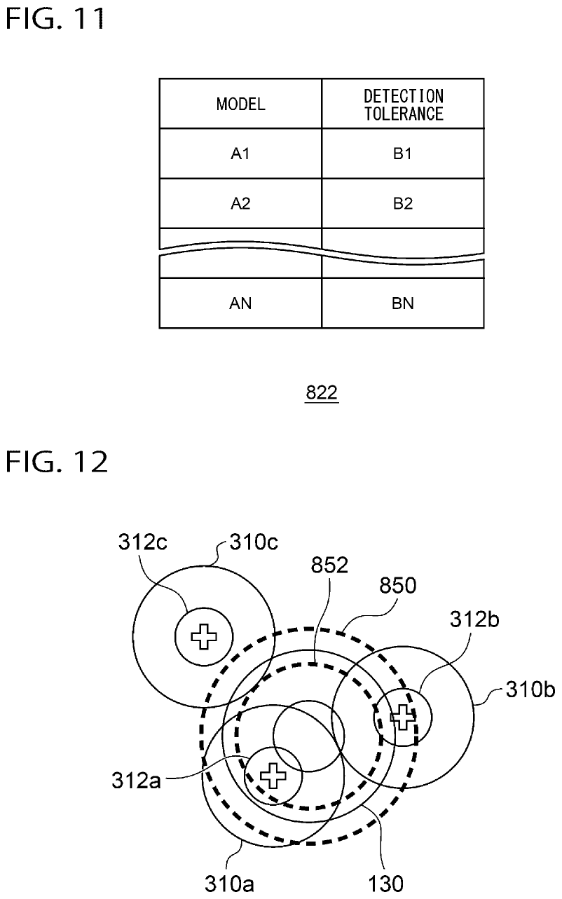

The detected position of the electronic appliance 300 deviates from the actual physical position of the electronic appliance 300 depending on the accuracy of measurement by the detection coil 132. This deviation is the detection tolerance. The detection tolerance may be calculated as either a distance (mm) of deviation from the actual physical position or a deviation ratio (%). In this case, a distance of deviation from the actual physical position will be used. In general, the detection tolerance differs from one model of the electronic appliance 300 to another. The table storage 822 of the common key storage 820 stores a table showing a correspondence between the model of the electronic appliance 300 that is placeable on the surface plate 112 and the detection tolerance for the detected position of the electronic appliance 300. FIG. 11 shows a data structure of the table stored in the table storage 822. For example, the model “A1” and the detection tolerance “B1” are mapped to each other. X-coordinate and Y-coordinate distances of deviation from the physical position are stored as the detection tolerance. For example, “B1”=1.1 mm, “B2”=2.2 mm are stored as the detection tolerance in X-axis coordinates, and “B1”=1.9 mm, “B2”=2.5 mm are stored as the detection tolerance in Y-axis coordinates. Return to Fig.

When the mutual authentication process in the authenticator 802 is successful, the electronic appliance communication unit of the electronic appliance 300 transmits a model notification to the charging apparatus 100. The model notification includes information related to the model of the electronic appliance 300. The receiver 544 of the charging apparatus 100 receives the model notification, and the acquirer 806 acquires the information related to the model of the electronic appliance 300 from the model notification received by the receiver 544. The extractor 808 extracts a detection tolerance from the table stored in the table storage 822 based on the information acquired by the acquirer 806.

In the following, FIG. 12 is also used to explain the impact of the difference between the position of the charging coil 130 and the detected position of the electronic appliance 300 and of the detection tolerance on charging. FIG. 12 shows an overview of the charging process in the charging apparatus 100. In FIG. 12, a first induction coil 310a through a third induction coil 310c are arranged at mutually different positions with respect to the charging coil 130. The first induction coil 310a through the third induction coil 310c all have a circular shape. The center of the first induction coil 310a is indicated as a first induction coil center 312a, the center of the second induction coil 310b is indicated as a second induction coil center 312b, and the center of the third induction coil 310c is indicated as a third induction coil center 312c. The first induction coil 310a through the third induction coil 310c are generically referred to as the induction coil 310, and the first induction coil center 312a through the third induction coil center 312c are generically referred to as the induction coil center 312.

A circular chargeable range 850 is defined to surround the circular charging coil 130 from outside. The chargeable range 850 is a range within which the electronic appliance 300 can be charged at a low voltage. Further, a circular fast chargeable range 852 is defined inside the charging coil 130. The fast chargeable range 852 is a range in which the electronic appliance 300 can be charged at a high voltage and is narrower than the chargeable range 850. The chargeable range 850 and the fast chargeable range 852 are configured based on an agreement between the manufacturer of the charging apparatus 100 and the manufacturer of the electronic appliance 300, or configured by the manufacturer of the charging apparatus 100 based on charging efficiency or the like.

Since the first induction coil center 312a is disposed inside the fast chargeable range 852, the charging apparatus 100 can execute high power charging of the electronic appliance 300 including the first induction coil 310a. Since the second induction coil center 312b is disposed outside the fast chargeable range 852 and inside the chargeable range 850, the charging apparatus 100 can execute low power charging of the electronic appliance 300 including the second induction coil 310b. Since the third induction coil center 312c is disposed outside the chargeable range 850, the charging apparatus 100 cannot charge the electronic appliance 300 including the third induction coil 310c.

The above-described difference corresponds to the distance between the center of the charging coil 130 and the induction coil center 312. This distance may be deviated by the detection tolerance. Therefore, a comparison with the chargeable range 850 and the fast chargeable range 852 may be made by assuming, for example, that the sum of the difference and the detection tolerance is the distance between the center of the charging coil 130 and the induction coil center 312. Reference is made back to FIG. 10.

The detection tolerance calculator 814 receives the coil diameter, inductance, and DC resistance communicated by the electronic appliance 300 by communication with the electronic appliance 300. The detection tolerance calculator 814 calculates the detection tolerance based on the coil diameter, inductance, and DC resistance. The table storage 822 stores a table including the detection tolerance calculated by the detection tolerance calculator 814.

When the sum of the difference and the detection tolerance is included in the chargeable range 850, the notification unit 810 generates a placement report so as to include the difference derived by the deriver 804 and the detection tolerance extracted by the extractor 808. The notification unit 810 transmits the placement report to the electronic appliance 300 via the transmitter 542. On the other hand, the notification unit 810 indicates that charging is not performed when the sum of the difference and the detection tolerance is not included in the chargeable range 850. For example, a message indicating that charging is not performed is displayed on a display provided in the charging apparatus 100. Alternatively, a lamp provided in the charging apparatus 100 may be lighted.

After transmitting the model notification to the charging apparatus 100, the electronic appliance 300 receives the placement report from the charging apparatus 100. The electronic appliance 300 determines whether to execute high power charging or low power charging based on the difference and detection tolerance included in the placement report. For example, the electronic appliance 300 determines the execution of high power charging when the sum of the difference and detection tolerance is included in the fast chargeable range 852 and determines the execution of low power charging when the sum of the difference and detection tolerance is not included in the fast chargeable range 852. This corresponds to determining high power when the magnitude of the combination of the difference and the detection tolerance is equal to or less than the threshold value and determining low power when the magnitude of the combination of the difference and the detection tolerance is greater than the threshold value. That is, when the detection tolerance is calculated as a distance, the fast chargeable range is defined as the threshold value. When the difference+the detection tolerance≤the threshold value, it is determined that high-power charging should be executed place, and, when the difference+the detection tolerance>the threshold value, it is determined that low-power charging should be executed. In the case of model “A1”, for example, when the X-coordinate detection tolerance “B1” is 1.1 mm and the threshold value is 2.0 mm, it is determined that high-power charging should be executed when the difference is 0.9 mm or less, and it is determined that low-power charging should be executed when the difference is greater than 0.9 mm. When the detection tolerance is calculated as a percentage of deviation from the actual physical position, the magnitude of the combination of the difference and the detection tolerance is calculated by multiplying the detection tolerance by the detection tolerance, and the magnitude is compared with the threshold value. Given that high power is called first power, low power is called second power. The magnitude of power may be defined in three or more stages instead of two stages comprised of high power and low power.

In “Power transfer” of S8, the electronic appliance communication unit of the electronic appliance 300 transmits a power instruction indicating high power charge or low power charging as determined to the charging apparatus 100. The receiver 544 of the charging apparatus 100 receives the power instruction from the electronic appliance 300. When the power instruction received by the receiver 544 indicates high power, the power controller 812 sets high power in the charging coil controller 700. The charging coil controller 700 causes a high power to be transported from the charging coil 130. When the power instruction received by the receiver 544 indicates low power, on the other hand, the power controller 812 sets low power in the charging coil controller 700. The charging coil controller 700 causes a low power to be transported from the charging coil 130. That is, the power controller 812 adjusts the magnitude of power to be transported from the charging coil 130 according to the power instruction.

This configuration can be implemented in hardware such as a CPU (Central Processor), a memory, or other LSI (Large Scale Integration), of any computer and in software such as a program loaded into a memory. The figures depict functional blocks implemented by the cooperation of these elements. Therefore, it will be understood by those skilled in the art that these functional blocks may be implemented in a variety of manners by hardware only or by a combination of hardware and software.

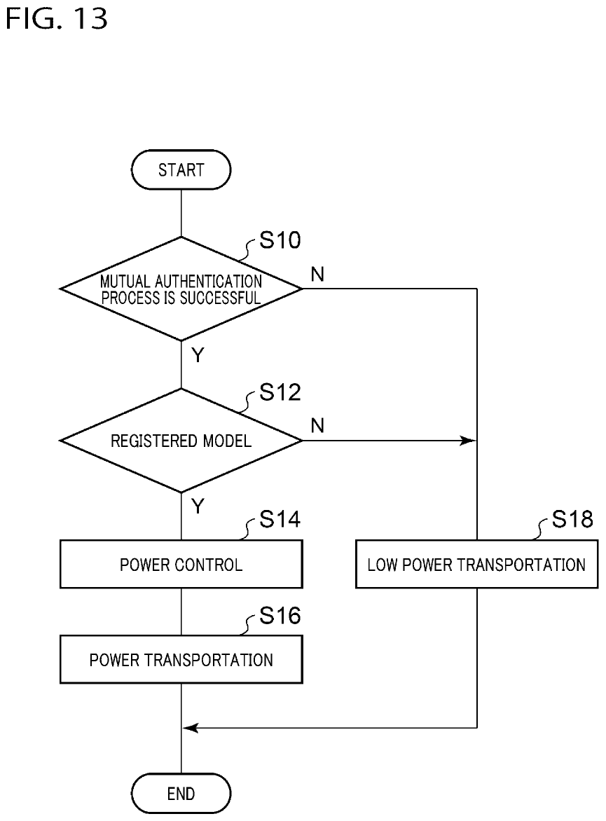

The operation of the charging apparatus 100 according to the above configuration will be described. FIG. 13 is a flowchart showing a charging procedure executed by the charging apparatus 100. When the mutual authentication process is successful in the authenticator 802 (Y in S10) and when the model of the electronic appliance 300 included in the model notification is already registered in the power controller 812 (Y in S12), power control is executed between the charging apparatus 100 and the electronic appliance 300 (S14). The power controller 812 causes the charging coil 130 to transport the power determined in the power control (S16). When the mutual authentication process is not successful in the authenticator 802 (N in S10) or when the model of the electronic appliance 300 included in the model notification is not registered in the power controller 812 (N in S12), the power controller 812 causes the charging coil 130 to transport low power (S18).

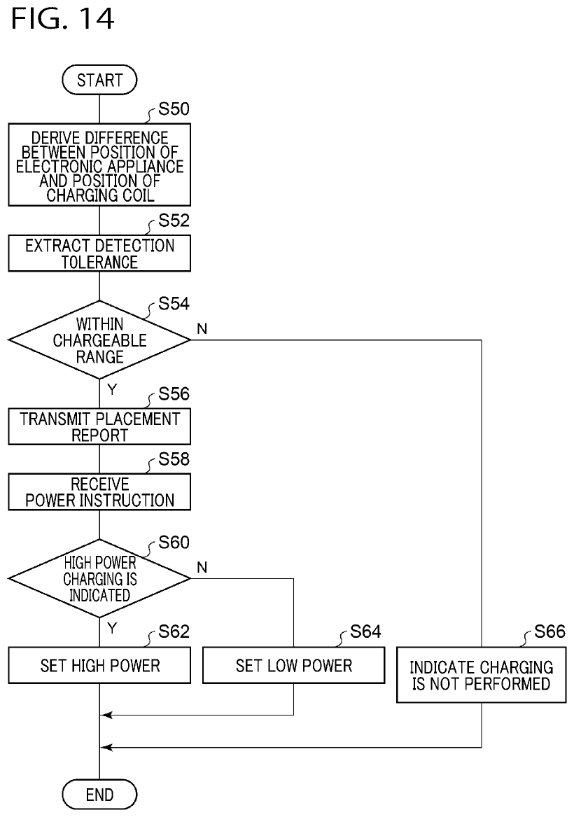

FIG. 14 is a flowchart illustrating another charging procedure executed by the charging apparatus 100. The deriver 804 derives the difference between the position of the electronic appliance 300 and the position of the charging coil 130 (S50). The extractor 808 extracts the detection tolerance corresponding to the model of the electronic appliance 300 from the table stored in the table storage 822 (S52). When the combination of the difference and the detection tolerance is within the chargeable range 850 (Y in S54), the transmitter 542 transmits a placement report to the electronic appliance 300 (S56). The receiver 544 receives a power instruction (S58). When high power charging is indicated in the power instruction (Y in S60), the power controller 812 sets a high power in the charging coil controller 700 (S62). When high power charging is not indicated in the power instruction (N in S60), the power controller 812 sets a low power in the charging coil controller 700 (S64). When the combination of the difference and the detection tolerance is not within the chargeable range 850 (N in S54), the notification unit 810 indicates that charging is not performed (S66).

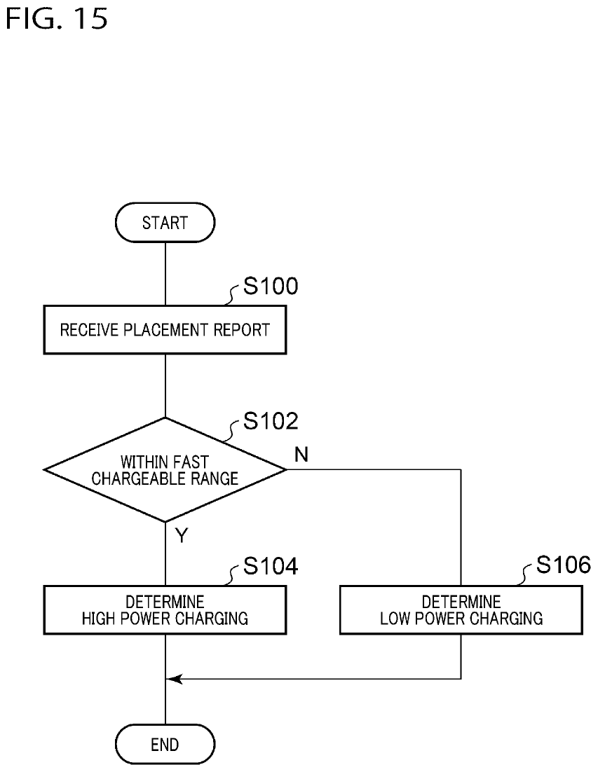

FIG. 15 is a flowchart showing a charging procedure executed by the electronic appliance 300. The electronic appliance 300 receives a placement report (S100). When the combination of the difference and the detection tolerance included in the placement report is within the fast chargeable range 852 (Y in S102), the electronic appliance 300 determines high power charging (S104). When the combination of the difference and the detection tolerance included in the placement report is not within the fast chargeable range 852 (N in S102), the electronic appliance 300 determines low power charging (S106).

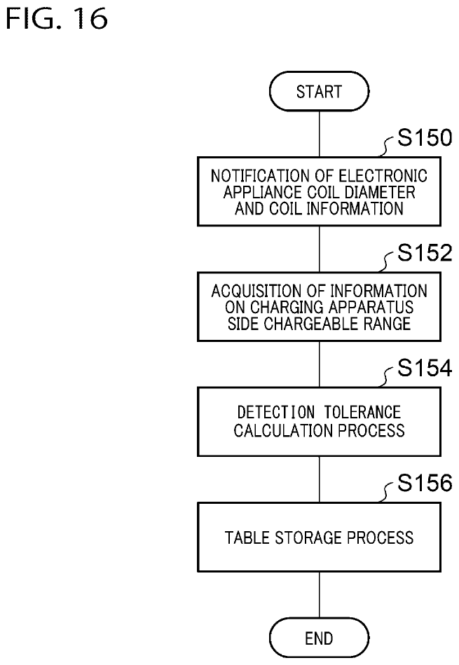

FIG. 16 is a flowchart showing a detection tolerance calculation procedure executed by the charging apparatus 100. The detection tolerance calculator 814 receives the coil diameter and coil information notification of the electronic appliance 300 (S150). The coil information notification includes the values of inductance and DC resistance. The detection tolerance calculator 814 acquires information on the chargeable range 850 on side of the charging apparatus 100 side (S152). The detection tolerance calculator 814 executes a process for calculating the detection tolerance based on these items of information (S154). The table storage 822 executes a process for storing a table including the calculation error (S156). The flowchart process of FIG. 16 can be executed in S7, S4, or the like, but the execution is not limited to these steps.

According to this embodiment, the magnitude of power to be transported from the charging coil is determined based on the difference between the position of the charging coil and the position of the electronic appliance and on the detection tolerance, so that the difference and the detection tolerance can be reflected in the magnitude of power. Further, since the difference and the detection tolerance are reflected in the magnitude of power, added value such as high power charging can be efficiently executed in wireless charging. Further, when the mutual authentication process is successful, information on the model of the electronic appliance is acquired, so that high-power charging is enabled in the case of a highly reliable electronic appliance. Further, since the mutual authentication process is executed in advance, it is possible to avoid providing functions such as high-power charging to inferior electronic appliances.

Further, low-power charging is executed when the mutual authentication process fails, so that wireless charging can be executed for electronic appliances. In addition, since low-power charging is executed when the mutual authentication process fails, compatibility with electronic appliances that do not support high-power charging can be secured. Further, since the common key is stored, the common key can be used for the mutual authentication process. Further, since the common key used in the mutual authentication process and the key used in the authentication process defined in the procedure for transporting power are different, separate authentication processes can be executed.

One embodiment of the present disclosure is summarized below. A charging apparatus according to an embodiment of the present disclosure is a charging apparatus for an electronic appliance that includes a built-in induction coil that is electromagnetically coupled and a built-in battery that is charged with power induced in the induction coil, the charging apparatus comprising: a support plate on which the electronic appliance is placeable; a detector that detects a position of the electronic appliance placed on the support plate; a deriver that derives a difference defined as a distance between a position of a charging coil for transporting power to the electronic appliance for which the position is detected by the detector and a position of the electronic appliance detected by the detector; a table storage that stores a table showing correspondence between a model of the electronic appliance placeable on the support plate and a detection tolerance occurring when the position of the electronic appliance is detected; an acquirer that acquires information related to the model of the electronic appliance by executing communication with the electronic appliance placed on the support plate; an extractor that extracts the detection tolerance from the table stored in the table storage, based on the information acquired by the acquirer; a transmitter that transmits the difference derived by the deriver and the detection tolerance detected by the detector to the electronic appliance; and a power controller that adjusts a magnitude of power to be transported from the charging coil according to an instruction from the electronic appliance to which the transmitter transmits the difference and the detection tolerance. The electronic appliance determines a first power when a magnitude of a combination of the difference and the detection tolerance is equal to or smaller than a threshold value and determines a second power when the magnitude of the combination of the difference and the detection tolerance is larger than the threshold value, and the first power is larger than the second power.

According to this embodiment, the magnitude of power to be transported from the charging coil is determined based on the difference between the position of the charging coil and the position of the electronic appliance and on the detection tolerance so that added value such as high power charging can be efficiently executed in wireless charging.

The table stored in the table storage may be configured such that correspondence to a new electronic appliance is appended to the table. In this case, the correspondence to a new electronic appliance is added to the table. Even if a highly reliable new electronic appliance emerges, therefore, it is possible to charge the electronic appliance with high power.

The charging apparatus may further include: a detection tolerance calculator that receives a coil diameter, inductance, and DC resistance communicated by the electronic appliance by communication with the electronic appliance and calculates the table based on the coil diameter, inductance, and DC resistance, wherein the table storage stores the table calculated by the detection tolerance calculator. In this case, the correspondence to a new electronic appliance is added to the table. Even if a highly reliable new electronic appliance emerges, therefore, it is possible to charge the electronic appliance with high power.

The charging apparatus may further include: an authenticator that executes a mutual authentication process encrypted by a common key by executing communication with the electronic appliance placed on the support plate. When the mutual authentication process by the authenticator is successful, the acquirer may acquire the information related to the model of the electronic appliance. In this case, when the mutual authentication process is successful, the information on the model of the electronic appliance is acquired so that high power charging is enabled in the case of a highly reliable electronic appliance.

When the mutual authentication process by the authenticator fails, the power controller may transport the second power. In this case, when the mutual authentication process fails, low-power charging is executed so that wireless charging can be executed for electronic appliances. The charging apparatus may further include: a common key storage that stores the common key. In this case, the common key is stored so that the common key can be used for the mutual authentication process.

The common key storage may store a common key for tests and a common key for operation as common keys. In this case, the common key for tests and the common key for operation are stored so that different common keys can be used for tests and for operation.

Following the mutual authentication process, the authenticator may execute an authentication process defined in a procedure for power transportation, and the common key used in the mutual authentication process and the key used in authentication process defined in the procedure for power transportation may be different. In this case, the common key used in the mutual authentication process and the key used in the authentication process defined in the procedure for transporting power are different so that separate authentication processes can be executed.

Described above is an explanation based on an exemplary embodiment. The embodiment is intended to be illustrative only and it will be understood by those skilled in the art that various modifications to constituting elements and processes could be developed and that such modifications are also within the scope of the present disclosure.

In the embodiment, the charging apparatus 100 is mounted on the vehicle 10. Alternatively, the charging apparatus 100 may not be, for example, mounted on the vehicle 10 and may be placed on a table or the like. According to this modification, the scope of application can be expanded. The charging coil 130 of the embodiment is driven by the Y axis motor 212 and the X axis motor 222 to move to the vicinity of the detected position to transport power. Alternatively, the charging coil 130 may be, for example, comprised of a plurality of charging coils 130. In this case, the charging coil 130 that covers the detected position is selected, and the selected charging coil 130 transports power. According to this modification, the flexibility of configuration can be improved.

The common key storage 820 of the embodiment stores the common key to be used for the mutual authentication process in “PreNegotiation”. Alternatively, the common key storage 820 may, for example, store a common key for tests and a common key for operation as common keys. The common key for tests is a common key for use in tests before productization. The common key for tests is used, for example, for the purpose of accreditation. The common key for operation is a common key for use at the time of productization and corresponds to the common key described in the embodiment. According to this variation, different common keys can be used before and after productization.

In the table stored in the table storage 822 of the embodiment, the correspondence between the model of the highly reliable electronic appliance 300 and the detection tolerance is shown. When a highly reliable new electronic appliance 300 emerges, the correspondence to the new electronic appliance 300 may be added to the table in this configuration. For example, the electronic appliance 300 (hereinafter referred to as “first electronic appliance 300”) for which the correspondence is already shown in the table stores the correspondence to the new electronic appliance 300 (hereinafter referred to as “second electronic appliance 300”). The first electronic appliance 300 executes communication with the charging apparatus 100 just the same as before and transmits the correspondence to the second electronic appliance 300 to the charging apparatus 100. The control apparatus 500 appends and stores the correspondence to the second electronic appliance 300 in the table storage 822. According to this variation, even if a highly reliable new electronic appliance emerges, it is possible to charge that electronic appliance with high power.

While various embodiments have been described herein above, it is to be appreciated that various changes in form and detail may be made without departing from the spirit and scope of the invention(s) presently or hereafter claimed.

### CROSS-REFERENCE TO RELATED APPLICATION

This application is based upon and claims the benefit of priority from the prior Japanese Patent Application No. 2021-092968, filed on Jun. 2, 2021, the entire contents of which are incorporated herein by reference.

What is claimed is:

1. A charging apparatus for an electronic appliance that includes a built-in induction coil that is electromagnetically coupled and a built-in battery that is charged with power induced in the induction coil,
the charging apparatus comprising:
a support plate on which the electronic appliance is placeable;
a detector that detects a position of the electronic appliance placed on the support plate;
a deriver that derives a difference defined as a distance between a position of a charging coil for transporting power to the electronic appliance for which the position is detected by the detector and a position of the electronic appliance detected by the detector;
a table storage that stores a table showing correspondence between a model of the electronic appliance placeable on the support plate and a detection tolerance occurring when the position of the electronic appliance is detected;
an acquirer that acquires information related to the model of the electronic appliance by executing communication with the electronic appliance placed on the support plate;
an extractor that extracts the detection tolerance from the table stored in the table storage, based on the information acquired by the acquirer;
a transmitter that transmits the difference derived by the deriver and the detection tolerance detected by the detector to the electronic appliance; and
a power controller that adjusts a magnitude of power to be transported from the charging coil according to an instruction from the electronic appliance to which the transmitter transmits the difference and the detection tolerance,
wherein the electronic appliance determines a first power when a magnitude of a combination of the difference and the detection tolerance is equal to or smaller than a threshold value and determines a second power when the magnitude of the combination of the difference and the detection tolerance is larger than the threshold value, and
wherein the first power is larger than the second power.

2. The charging apparatus according to claim 1,
wherein the table stored in the table storage is configured such that correspondence to a new electronic appliance is appended to the table.

3. The charging apparatus according to claim 1, further comprising:
a detection tolerance calculator that receives a coil diameter, inductance, and DC resistance communicated by the electronic appliance by communication with the electronic appliance and calculates the table based on the coil diameter, inductance, and DC resistance,
wherein the table storage stores the table calculated by the detection tolerance calculator.

4. The charging apparatus according to claim 1, further comprising:
an authenticator that executes a mutual authentication process encrypted by a common key by executing communication with the electronic appliance placed on the support plate,
wherein, when the mutual authentication process by the authenticator is successful, the acquirer acquires the information related to the model of the electronic appliance.

5. The charging apparatus according to claim 2, further comprising:
an authenticator that executes a mutual authentication process encrypted by a common key by executing communication with the electronic appliance placed on the support plate,
wherein, when the mutual authentication process by the authenticator is successful, the acquirer acquires the information related to the model of the electronic appliance.

6. The charging apparatus according to claim 3, further comprising:
an authenticator that executes a mutual authentication process encrypted by a common key by executing communication with the electronic appliance placed on the support plate,
wherein, when the mutual authentication process by the authenticator is successful, the acquirer acquires the information related to the model of the electronic appliance.

7. The charging apparatus according to claim 4,
wherein, when the mutual authentication process by the authenticator fails, the power controller transports the second power.

8. The charging apparatus according to claim 5,
wherein, when the mutual authentication process by the authenticator fails, the power controller transports the second power.

9. The charging apparatus according to claim 6,
wherein, when the mutual authentication process by the authenticator fails, the power controller transports the second power.

10. The charging apparatus according to claim 4, further comprising:
a common key storage that stores the common key.

11. The charging apparatus according to claim 10,
wherein the common key storage stores a common key for tests and a common key for operation as common keys.

12. The charging apparatus according to claim 4,
wherein, following the mutual authentication process, the authenticator executes an authentication process defined in a procedure for power transportation, and
wherein the common key used in the mutual authentication process and the key used in authentication process defined in the procedure for power transportation are different.
